(19) United States
(12) Patent Application Publication
(10) Pub. No.: US 2008/0313066 A1
(43) Pub. Date: Dec. 18, 2008

(54) METHOD AND SYSTEM FOR MANAGING RECEIPTS

(76) Inventors: Steven Sholtis, El Dorado Hills, CA (US); Billy Yuen, Mountain View, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/761,463

(22) Filed: Jun. 12, 2007

(51) Int. Cl. G06Q 40/00

(52) U.S. Cl. 705/35

(57) ABSTRACT

A method and system for managing receipts includes a process for managing receipts whereby when a user makes a purchase of a product and/or service, an electronic copy of the data on the purchase receipt is generated. The purchase receipt data is then assigned an identification code unique to the user to create user correlated purchase receipt data. The user correlated purchase receipt data is then transferred to a data storage device where the user correlated purchase receipt data is stored until needed. The user correlated purchase receipt data is then made accessible to the user, and/or an authorized agent for the user, as needed, by accessing the data on the data storage device through a user account.

### BACKGROUND

Consumers are often required to show proof, and/or an itemized record, of product and/or service purchases in order to obtain rights/privileges associated with the purchases. For instance, detailed and/or itemized proof of a purchase of a product and/or service is often required by local, and/or state, and/or Federal, tax agencies in order to qualify for a tax deduction associated with the purchase. Likewise, many healthcare spending account programs such a Flexible Spending Accounts (FSAs), Healthcare Spending Accounts (HSAs), and Healthcare Reimbursement Arrangements (HRAs), as well as healthcare insurance providers in general, often require a detailed and itemized record and/or proof of product and/or service purchases before the consumer can be reimbursed for a legitimate healthcare expense. In addition, almost all businesses require an employee to submit detailed and itemized proof of business related purchases before the employee can be reimbursed. In addition, many retailers require detailed and itemized proof of a given purchase of a product and/or service before that product and/or service can be returned, refunded, and/or exchanged.

Currently, printed purchase receipts are the most widely accepted, and, at times, the only, detailed and itemized record and/or source of information regarding the literally hundreds of purchases made each year by the average consumer. Consequently, purchase receipts are often an important tool used by consumers to, among other things, prove/record various information associated with a given purchase such as, but not limited to: the purchase itself; the purchase amount; the item(s) purchased; the date of purchase; the location of purchase; and various other information associated with a given purchase.

Despite the importance of purchase receipts to most consumers, these receipts are often discarded and/or lost by the consumer. Consequently, many consumers forfeit significant rights, and sums of money, each year by virtue of having failed to save their purchase receipts. This failure to properly maintain and manage purchase receipts is, to a significant degree, a result of the fact that the vast majority of purchase receipts are provided to the consumer in a printed paper format. This fact, combined with the fact that the average American consumer is given literally hundreds, and often thousands, of receipts each year, means that most consumers cannot produce many important purchase receipts when they are needed. In addition, the rare consumer who does decide to keep all of his or her receipts is then faced with an overwhelming document storage and management issue.

The problem described above is particularly acute for cash-based transactions where the purchase receipt is often the only record of the transaction. However, even using a credit and/or debit card and/or device, and then relying on a periodic account transaction record from the account provider, still often fails to solve the problem. This is because, while many credit and/or debit card/device accounts do provide a consumer with a rudimentary record of a financial transaction, the information provided is typically not itemized and/or detailed enough to meet the proof requirements imposed by most tax agencies, health insurance companies, healthcare spending account administrators, employer's accounting departments, retailers, and various other parties and/or institutions.

As an example, a consumer might purchase the following five items at a drug store using his credit card: a first prescription for $20.00; a second prescription for $20.00; shampoo for $15.00; candy for $5.00; and a case of soda for $10.00. Further assume that only the $40.00 for the first and second prescriptions are eligible for reimbursement under one or more of the consumer's healthcare spending accounts. Typically, the purchase receipt would show an itemized listing of the five purchased items along with the price paid for each, the store, and/or store location, the date of the purchase, and various other information associated with the purchased items. In contrast, a typical credit card statement would only show the total transaction amount of $70.00 and, sometimes, the store name, and date of purchase, more often only the date the transaction posted to the credit account. Consequently, if the consumer were to rely on the credit card statement as proof of the eligible prescription purchase, he would typically be refused reimbursement by the healthcare spending account administrator due to the lack of itemization and/or detail provided by the credit card statement. Similarly, tax agencies and most employers also often refuse to recognize the average credit card statement as proof of a given purchase.

As a result of the situation discussed above, currently, the average consumer can either choose to discard purchase receipts, thereby forfeiting significant rights and/or privileges associated with his or her purchases, or he or she can choose to keep his or her purchase receipts and thereby incur a significant document storage and management burden.

### SUMMARY

In accordance with one embodiment, a system and method for managing receipts includes a process for managing receipts whereby when a user makes a purchase of a product and/or service, an electronic copy of at least part of the data on the purchase receipt is generated. The purchase receipt data is then assigned an identification code unique to the user to create user correlated purchase receipt data. In one embodiment, the user correlated purchase receipt data is then transferred to a data storage device where the user correlated purchase receipt data is stored until needed. In one embodiment, the user correlated purchase receipt data is then made accessible to the user, and/or an authorized agent for the user, for direct use and/or further processing by accessing the data storage device.

In one embodiment, the process for managing receipts is a module, a sub-program, a component, a plug-in, or a feature of, a parent computing system implemented application and/or system, such as a computing system implemented point of sale system, a computing system implemented accounting system, and/or a computing system implemented financial management system, employed by a retailer and/or the user.

In one embodiment, when the user makes the purchase of a product and/or service, the purchase receipt data used by the parent computing system implemented point of sale system to generate an itemized printed receipt is also transferred to the process for managing receipts. In one embodiment, the process for managing receipts then associates the purchase receipt data with the identification code unique to the user to the create user correlated purchase receipt data.

In one embodiment, the identification code unique to the user is chosen by the user. In one embodiment, the identification code unique to the user is taken from other unique user data, such as the user's telephone number or name. In one embodiment, the identification code unique to the user is obtained from a credit and/or debit card used to make the purchase. In one embodiment, the identification code unique to the user is obtained from a credit and/or debit device, such as a cell phone, Personal Digital Assistant (PDA), memory device/stick, smart card, or other computing device and/or system having an identification code unique to the user.

In one embodiment, the user correlated purchase receipt data is transferred to a data storage device where the user correlated purchase receipt data is stored until needed. In one embodiment, the data storage device is database such as a designated server system or computing system, or a designated portion of one or more server systems or computing systems, or a distributed database, or an external and/or portable data storage device. In one embodiment, the data storage device is a dedicated mass storage device implemented in software, hardware, or a combination of hardware and software. In one embodiment, the data storage device is a web-based function. In one embodiment, the data storage device is a computer program product as defined herein. In one embodiment, the data storage device is a portable computing system and/or device, such as a cell phone, PDA, memory device/stick, smart card, or other computing device and/or system having a data storage capability.

In one embodiment, the user correlated purchase receipt data for all of the known user's purchases is stored in a single account assigned to the user and/or the user's agents. In one embodiment, the purchase receipt data is then made accessible to the user, and/or any authorized agents for the user, and/or any party authorized by the user, and/or any authorized program and/or electronic agent of the user, by providing access to the user's account.

In one embodiment, the user correlated purchase receipt data is processed by the process for managing receipts to create purchase receipt data reports and/or displays using user and/or provider criteria such as, but not limited to: the product and/or service purchased; a category for the product and/or service purchased; the purchase amount; the date of purchase; the location of purchase; and any other criteria associated with a given purchase designated by the user, the user's agents, the provider of the process for managing receipts or a parent system, and/or any other party.

In one embodiment, the user correlated purchase receipt data is transferred by the process for managing receipts to another computing system implemented management system such as, but not limited to: a computing system implemented personal financial management system; a computing system implemented business financial management system; a computing system implemented personal accounting system; a computing system implemented business accounting system; a computing system implemented tax preparation system; a computing system implemented healthcare management system; or any other a computing system implemented personal and/or business management system. In one embodiment, once the user correlated purchase receipt data is transferred by the process for managing receipts to a second computing system implemented management system, the second computing system implemented management system processes the user correlated purchase receipt data to create purchase receipt data reports and/or displays using user and/or provider criteria such as, but not limited to: the product and/or service purchased; the category of the product and/or service purchased; purchase amount; the date of purchase; the location of purchase; and any other criteria associated with a given purchase designated by the user, the user's agents, the provider of process for managing receipts, the provider of the second computing system implemented management system, and/or any other party.

Using the system and method for managing receipts, and a process for managing receipts, discussed herein, a user is provided the ability to receive, store and manage detailed purchase receipt data automatically, without having to receive, retain, or worry about/bother with, paper receipts. Consequently, using the system and method for managing receipts, and a process for managing receipts, discussed herein, a user can keep a detailed record of his or her purchases, and thereby retain all his or her rights and/or privileges associated with his or her purchases, without taking on the burden of receiving, storing, and managing hundreds, and even thousands, of documents each year. Consequently, the user is provided the opportunity to retain more detailed records, and provide required proof of purchases when needed, with little, or no, burden being imposed on the user.

As discussed in more detail below, using the below embodiments, with little or no modification and/or user input, there is considerable flexibility, adaptability, and opportunity for customization to meet the specific needs of various users under numerous circumstances.

### BRIEF DESCRIPTION OF THE DRAWINGS

FIG. 1 is a block diagram of an exemplary hardware architecture for implementing one embodiment;

FIG. 2 is a flow chart depicting a process for managing receipts in accordance with one embodiment; and

FIG. 3 is a flow chart depicting a process for managing receipts in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be embodied in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

Some embodiments are implemented in a computing system including a conventional computing system running a conventional operating system such as those distributed by Microsoft Corporation of Redmond Wash.; Apple Computer Inc. of Cupertino Calif.; any Unix operating system; any Linux operating system; the Palm OS series of operating systems; or any other operating system designed to generally manage operations on a computing system, whether known at the time of filing or as developed later. Some embodiments are implemented in a mobile computing system running mobile operating systems such as Symbian® OS, Windows® Mobile, or any other operating system designed to generally manage operations on a mobile computing system, whether known at the time of filing or as developed later. As described more fully below, embodiments can be implemented on computing systems other than a conventional computing system such as, for example, a personal digital assistant, a cell phone, or other computing system capable of processing computer readable data, whether known at the time of filing or as developed later. Computing systems also include those in which one or more computing resources (hardware or software) are located remotely and accessed via a network, such as a peer-to-peer and/or hybrid peer-to-peer network, a Local Area Network (LAN), User Datagram Protocol (UDP) network, Short Message Service (SMS) network, a Wide Area Network (WAN), a public network, such as the Internet, a private network, a combination of network types, a computing system bus, or other electronic medium in which data may be exchanged between one computing system and one or more other computing system(s), whether known at the time of filing or as developed later. Embodiments may be included as add-on software for existing software programs, packages or applications, and embodiments may be a feature of an application that is bundled with a computing system or sold separately. Some embodiments may also be implemented as functionality embedded in hardware devices and systems.

Output generated by one or more embodiments can be displayed on a display screen, delivered from a website and/or web-based function, transmitted to a remote device, stored on any database, computer server or other storage mechanism, printed, or used in any other way. In addition, in some embodiments, processes and/or systems described herein may make use of input provided to the computer device implementing a process and/or application, discussed herein, via user interface devices such as a keyboard, mouse, touchpad, or any other device capable of providing user input to a computing system or for translating user actions into computing system operations, whether known at the time of filing or as developed later.

### Hardware System Architecture

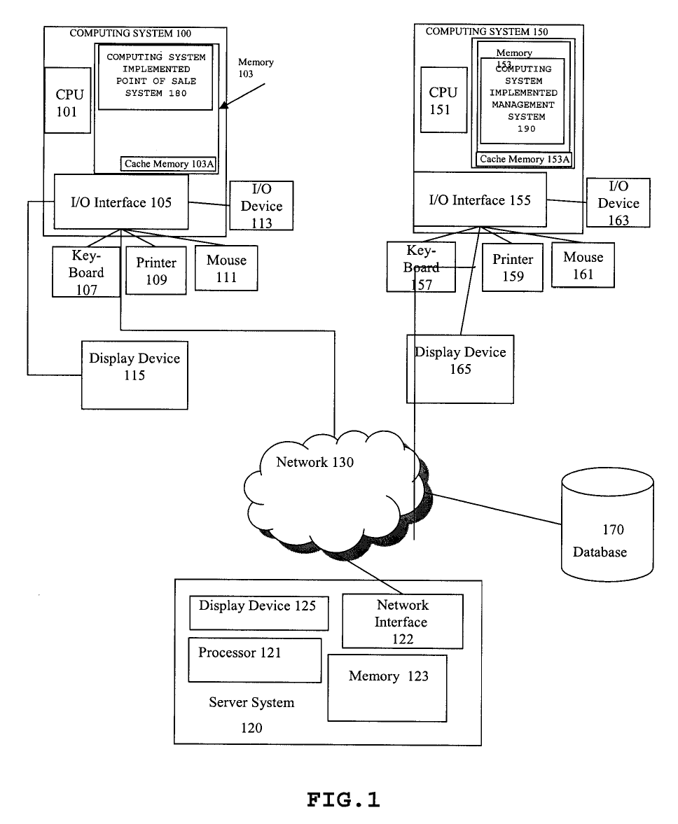

FIG. 1 is a block diagram of an exemplary hardware architecture for implementing one embodiment of a system and method for managing receipts, such as exemplary processes 200 and 300 discussed herein, that includes: a computing system 100, e.g., a first computing system; a computing system 150, e.g., a second computing system; a server system 120; and a database 170, all operatively coupled by a network 130.

As seen in FIG. 1, computing system 100 typically includes a central processing unit (CPU) 101, an input/output (I/O) interface 105, and a memory system 103, including cache memory 103A. In one embodiment, memory system 103 includes all, or part of, a computing system implemented point of sale system 180, stored, in whole, or in part, therein, that is used by, or includes, as discussed below, a process for managing receipts, such as exemplary processes 200 and 300 discussed below.

Computing system 100 may further include standard user interface devices such as a keyboard 107, a mouse 111, a printer 109, and a display device 115, as well as, one or more standard input/output (I/O) devices 113, such as a compact disk (CD) or Digital Video Disc (DVD) drive, floppy disk drive, or other digital or waveform port, or other device capable of inputting data to, and outputting data from, computing system 100, whether available or known at the time of filing or as later developed. As discussed in more detail below, in one embodiment, a process for managing receipts and/or a computing system implemented point of sale system are entered, in whole, or in part, into computing system 100 via I/O device 113, such as from a CD, DVD, floppy disk, portable hard drive, memory stick, download site, or other medium and/or computer program product as defined herein.

In one embodiment, computing system 100 is a computing system used and/or accessible by another computing system, such as computing system 150 (discussed below), a workstation, a two-way pager, a cellular telephone, a smart phone, a digital wireless telephone, a Personal Digital Assistant (PDA), a server computer, an Internet appliance, any other device, or any desired combination of these devices, that includes components that can execute all, or part, of a process for managing receipts, and/or a computing system implemented point of sale system, in accordance with at least one of the embodiments as described herein.

Similarly, computing system 150 typically includes a CPU 151, an input/output (I/O) interface 155, and a memory system 153, including cache memory 153A. Similar to computing system 100, computing system 150 may further include standard user interface devices such as a keyboard 157, a mouse 161, a printer 159, and a display device 165, as well as, one or more standard input/output (I/O) devices 163, such as a compact disk (CD) or DVD drive, floppy disk drive, or other digital or waveform port, or other device capable of inputting data to, and outputting data from, computing system 150, whether available or known at the time of filing or as later developed.

In one embodiment, memory system 153 includes all, or part of, a computing system implemented management system 190 such as, but not limited to: a computing system implemented personal financial management system; a computing system implemented business financial management system; a computing system implemented personal accounting system; a computing system implemented business accounting system; a computing system implemented tax preparation system; a computing system implemented healthcare management system; or any other a computing system implemented personal and/or business management system.

As discussed in more detail below, in one embodiment, all, or part of, a process for managing receipts, and/or a computing system implemented point of sale system, and/or a computing system implemented management system can be loaded, in whole, or in part, into computing system 150 from computing system 100 for storage in memory system 153 and/or cache memory 153A.

Also shown in FIG. 1 is exemplary database 170. In one embodiment, database 170 is a data storage device, a designated server system or computing system, or a designated portion of one or more server systems or computing systems, such as computing systems 100, 150 and 120, or a distributed database, or an external and/or portable hard drive. In one embodiment, database 170 is a dedicated mass storage device implemented in software, hardware, or a combination of hardware and software. In one embodiment, database 170 is a web-based function. As discussed in more detail below, in one embodiment, database 170 is under the control of the user, and/or the user's agents, and/or a process for managing receipts, such as exemplary processes 200 and 300, and/or a computing system implemented process, such as a computing system implemented point of sale system 180 and/or computing system implemented management system 190.

In one embodiment, database 170 is used, controlled, and/or accessible by a provider of and/or a system and process for managing receipts, such as processes for managing receipts 200 and 300. In one embodiment, database 170 is used, controlled, and/or accessible by a provider of and/or a computing system implemented point of sale system, such as computing system implemented point of sale system 180. In one embodiment, database 170 is used, controlled, and/or accessible by a provider of and/or a computing system implemented management system, such as computing system implemented management system 190. In one embodiment, computing systems 100 and 150, and database 170, are coupled to a server system 120 through network 130. In one embodiment, server system 120 typically includes a server system display device 125, a server system processor 121, a server system memory 123, and a server system network interface 122.

In one embodiment, server system 120 is used in a station-to-station arrangement, such as a peer-to-peer, or hybrid peer-to peer, arrangement, as an indexing and/or central server used to connect a first computing system, such as computing system 100, and a second computing system, such as computing system 150.

Network 130 can be any network or network system that is of interest to a user such as, a peer-to-peer network, a hybrid peer-to-peer network, a Local Area Network (LAN), a Wide Area Network (WAN), a public network, such as the Internet, a private network, a combination of different network types, or other wireless, wired, and/or a wireless and wired combination network capable of allowing communication between two or more computing systems, whether available or known at the time of filing or as later developed.

Those of skill in the art will readily recognize that the components shown in FIG. 1, such as computing systems 100 and 150, database 170, server system 120, and their respective components, are shown for illustrative purposes only and that architectures with more or fewer components can implement, and benefit from, the invention. Moreover, one or more components of computing system 100, computing system 150, database 170, and server system 120 may be located remotely from their respective system and accessed via a network, as discussed herein. In addition, the particular type of, and configuration of, computing systems 100 and 150, database 170, and server system 120 are not relevant.

As discussed in more detail below, in one embodiment, a process for managing receipts, such as processes for managing receipts 200 and 300, and/or a computing system implemented point of sale system, such as computing system implemented point of sale system 180, and/or a computing system implemented management system, such as computing system implemented management system 190, are stored, in whole, or in part, in memory system 103 and/or cache memory 103A, of computing system 100, and/or memory system 153 and/or cache memory 153A of computing system 150, and/or in server memory system 123 of server system 120 and/or in database 170, and executed on computing system 100 and/or computing system 150. As used herein, a memory refers to a volatile memory, a non-volatile memory, or any combination of the two.

Although a process for managing receipts, such as processes for managing receipts 200 and 300, and/or a computing system implemented point of sale system, such as computing system implemented point of sale system 180, and/or a computing system implemented management system, such as computing system implemented management system 190, are sometimes referred to herein, alternatively, as a process, an application, a module, a program, a component of a software system, a component of a software package, a component of a parent system, a plug-in, or a feature of a parent system, this terminology is illustrative only. In some embodiments, a process for managing receipts, such as processes for managing receipts 200 and 300, and/or a computing system implemented point of sale system, such as computing system implemented point of sale system 180, and/or a computing system implemented management system, such as computing system implemented management system 190, are capable of being called from an application or the operating system. In one embodiment, an application, process, or program is generally defined to be any executable code. Moreover, those of skill in the art will understand that when it is said that an application, process, or an operation takes some action, the action is the result of executing one or more instructions by a processor, such as CPUs 101 and 151, or server system processor 121. In one embodiment, execution of a process by CPU 101, CPU 151, or server system processor 121, results in the operations of an agent computer process (not shown) and/or a rule computer process (not shown).

In one embodiment, a process for managing receipts, such as processes for managing receipts 200 and 300, and/or a computing system implemented point of sale system, such as computing system implemented point of sale system 180, and/or a computing system implemented management system, such as computing system implemented management system 190, are computer applications or processes and/or data implemented and/or run and/or stored, in full, or in part, in, or on, a computer program product. Herein, a computer program product comprises a medium and/or I/O device configured to store or transport computer readable code, whether available or known at the time of filing or as later developed. Some examples of computer program products are CDs, DVDs, ROM cards, floppy discs, magnetic tapes, computer hard drives, portable hard drives, flash memory, volatile and non-volatile memory sticks, servers on a network, such as server system 120 of FIG. 1, and signals transmitted over a network, such as network 130 of FIG. 1, or other media or process capable of delivering computer readable data representing computer readable code, whether available or known at the time of filing or as later developed. This medium may belong to a computing system, such as computing systems 100 and 150 of FIG. 1, described above. However, in some embodiments, the medium also may be removable and/or remote from the computing system.

For example, all, or part, of a process for managing receipts, such as processes for managing receipts 200 and 300, and/or a computing system implemented point of sale system, such as computing system implemented point of sale system 180, and/or a computing system implemented management system, such as computing system implemented management system 190, may be stored in a memory that is physically located in a location, such as server system memory 123, or database 170, of FIG. 1, different from a computing system, such as computing systems 100 and/or 150 of FIG. 1, utilizing a process for managing receipts, and/or a computing system implemented point of sale system, and/or computing system implemented management system. In one embodiment, all, or part, of a process for managing receipts, and/or a computing system implemented point of sale system, and/or a computing system implemented management system, may be stored in a memory that is physically located, separate from the computing system's processor(s), such as CPUs 101 and 151 of FIG. 1, and the computing system CPUs can be coupled to the memory in a client-server system, such as server system 120 of FIG. 1, or, alternatively, via connection to another computer, such as computing systems 100, 150 of FIG. 1, via modems and analog lines, digital interfaces and a digital carrier line, or wireless or cellular connections.

In one embodiment, the computing systems and/or server systems, such as computing systems 100 and/or 150 and/or server system 120 of FIG. 1, running and/or utilizing and/or storing all, or part, of a process for managing receipts, such as processes for managing receipts 200 and 300, and/or a computing system implemented point of sale system, such as computing system implemented point of sale system 180, and/or a computing system implemented management system, such as computing system implemented management system 190, is a portable computer, a workstation, a two-way pager, a cellular telephone, a smart phone, a digital wireless telephone, a PDA, a server computer, an Internet appliance, or any other device that includes components that can execute all, or part, of a process for managing receipts, and/or a computing system implemented point of sale system, and/or a computing system implemented management system, in accordance with at least one of the embodiments as described herein. Similarly, in another embodiment, a process for managing receipts, and/or a computing system implemented point of sale system, and/or a computing system implemented management system, may be implemented on and/or run and/or stored on a computing system and/or server system that is comprised of multiple different computers, wireless devices, cellular telephones, digital telephones, two-way pagers, personal digital assistants, server computers, or any desired combination of these devices, that are coupled to perform the processes and/or operations as described herein.

### Process

Herein, the terms “user” and/or “consumer” are used interchangeably to denote any individual, and/or any agent of an individual, implementing, and/or interfacing with, and/or making purchases the provide data to and/or generate data for, a system and method for managing receipts and/or a process for managing receipts, as disclosed herein. As an example, herein the terms “user” and/or “consumer” can be, but are not limited to, a party making purchases and/or generating receipt data that is provided to, and/or processed by, a system and method for managing receipts and/or a process for managing receipts.

Herein, the terms “seller” and/or “retailer” are used interchangeably to denote any individual, organization, entity, institution, and/or computing implemented system employed by the same, that sells and/or offers for sale, a product and/or service purchased by a user. As an example, herein the terms “seller” and/or “retailer” can be used to denote, but are not limited to, any party and/or point of sale program and/or device generating purchase receipt data for a system and method for managing receipts and/or a process for managing receipts, as disclosed herein. Herein the terms “seller” and/or “retailer” can be used to denote any party and/or point of sale program and/or device at the location of the user, or remotely located from the user, at the time of purchase.

Herein, the terms “receipt data” and/or “electronic receipt” and/or “electronic copy of receipt data” are used to denote any data pertaining to a purchase made by a user. As an example, herein, the terms “receipt data” and/or “electronic receipt” and/or “electronic copy of receipt data” can denote, but are not limited to, any of the following: a scanned image of a receipt; selected data from a scanned image of a receipt; a purchase date of a product and/or service purchased; a purchase amount of a product and/or service purchased; identification of a product and/or service purchased; identification data associated with the purchaser of the a product and/or service purchased; a retailer/seller of the product and/or service purchased; the location and/or contact information of the retailer/seller of the product and/or service purchased; an account number of a debit or credit account used to purchase the product and/or service; and/or any other data/information that is related to a purchases of a product and/or service.

In accordance with one embodiment, a system and method for managing receipts includes a process for managing receipts whereby when a user makes a purchase of a product and/or service, an electronic copy of at least part of the data on the purchase receipt is generated. The purchase receipt data is then assigned an identification code unique to the user to create user correlated purchase receipt data. In one embodiment, the user correlated purchase receipt data is then transferred to a data storage device where the user correlated purchase receipt data is stored until needed. In one embodiment, the user correlated purchase receipt data is then made accessible to the user, and/or an authorized agent for the user, for direct use and/or further processing.

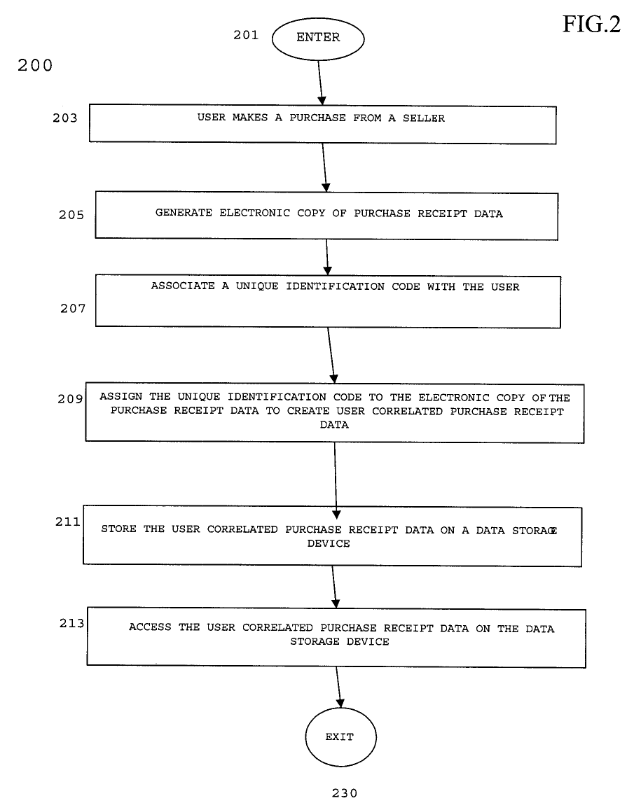

FIG. 2 a flow chart depicting a process for managing receipts 200 in accordance with one embodiment. Process for managing receipts 200 begins at ENTER OPERATION 201 of FIG. 2 and process flow proceeds to USER MAKES A PURCHASE FROM A SELLER OPERATION 203.

As noted above, herein, the terms “user” and/or “consumer” are used interchangeably to denote any individual, and/or any agent of an individual, implementing, and/or interfacing with, and/or making purchases the provide data to and/or generate data for, a system and method for managing receipts and/or a process for managing receipts, as disclosed herein. As an example, herein the terms “user” and/or “consumer” can be, but are not limited to, a party making a purchases and/or generating receipt data that is provided to, and/or processed by, a system and method for managing receipts and/or a process for managing receipts.

As also noted above, herein, the terms “seller” and/or “retailer” are used interchangeably to denote any individual, organization, entity, institution, and/or computing implemented system employed by the same, that sells and/or offers for sale, a product and/or service purchased by a user. As an example, herein the terms “seller” and/or “retailer” can be used to denote, but are not limited to, any party and/or point of sale program and/or device generating purchase receipt data for a system and method for managing receipts and/or a process for managing receipts, as disclosed herein. Herein the terms “seller” and/or “retailer” can be used to denote any party and/or point of sale program and/or device at the location of the user, or remotely located from the user, at the time of purchase.

In one embodiment, at USER MAKES A PURCHASE FROM A SELLER OPERATION 203, a user purchases a product and/or a service from a seller of the product and/or a service. In one embodiment, at USER MAKES A PURCHASE FROM A SELLER OPERATION 203, a user purchases a product and/or a service from a seller of the product and/or a service at the seller facility and/or in person. In one embodiment, at USER MAKES A PURCHASE FROM A SELLER OPERATION 203, a user purchases a product and/or a service from a seller of the product and/or a service remotely via a computing system and network, such as the Internet. In one embodiment, at USER MAKES A PURCHASE FROM A SELLER OPERATION 203, a user purchases a product and/or a service from a seller of the product and/or a service via mail or by telephone order.

In one embodiment, at USER MAKES A PURCHASE FROM A SELLER OPERATION 203, a user purchases a product and/or a service from a seller of the product and/or a service via any means and/or mechanism for making a purchase, whether known at the time of filing or as developed thereafter.

In one embodiment, once a user purchases a product and/or a service from a seller of the product and/or a service at USER MAKES A PURCHASE FROM A SELLER OPERATION 203, process flow proceeds to GENERATE ELECTRONIC COPY OF PURCHASE RECEIPT DATA OPERATION 205.

In one embodiment, at GENERATE ELECTRONIC COPY OF PURCHASE RECEIPT DATA OPERATION 205 the seller creates a purchase receipt associated with, and recording the purchase of, the product and/or service of USER MAKES A PURCHASE FROM A SELLER OPERATION 203. In one embodiment, at GENERATE ELECTRONIC COPY OF PURCHASE RECEIPT DATA OPERATION 205, at least a portion of the information contained on the purchase receipt is used to generate an electronic copy of the purchase receipt data.

As noted above, herein, the terms “receipt data” and/or “electronic receipt” and/or “electronic copy of purchase receipt data” are used to denote any data pertaining to a purchase made by a user. As an example, herein, the terms “receipt data” and/or “electronic receipt” and/or “electronic copy of purchases receipt data” can denote, but are not limited to, any of the following: a scanned image of a receipt; selected data from a scanned image of a receipt; a purchase date of a product and/or service purchased; a purchase amount of a product and/or service purchased; identification of a product and/or service purchased; identification data associated with the purchaser of the a product and/or service purchased; a retailer/seller of the product and/or service purchased; the location and/or contact information of the retailer/seller of the product and/or service purchased; an account number of a debit or credit account used to purchase the product and/or service; and/or any other data/information that is related to a purchases of a product and/or service as designated by the user, the user's agents, the seller, the provider of process for managing receipts 200, and/or any other party.

In one embodiment, the original purchase receipt is in an electronic format and the electronic “copy” of the of the purchase receipt data of GENERATE ELECTRONIC COPY OF PURCHASE RECEIPT DATA OPERATION 205 is identical with the original purchase receipt.

In one embodiment, the original purchase receipt is in paper and/or printed format and the electronic copy of the of the purchase receipt data of GENERATE ELECTRONIC COPY OF PURCHASE RECEIPT DATA OPERATION 205 is obtained by scanning the original purchase receipt information into a computing system and then providing the electronic copy of the of the purchase receipt data to process for managing receipts 200 by methods well known to those of skill in the art.

In one embodiment, at GENERATE ELECTRONIC COPY OF PURCHASE RECEIPT DATA OPERATION 205, at least a portion of the information contained on the purchase receipt is obtained and used to generate an electronic copy of the purchase receipt data by transferring purchase receipt data from a computing system controlled by the seller, such as computing system 100 of FIG. 1, and/or a seller's computing system implemented point of sale system, such as computing system implemented point of sale system 180 of FIG. 1, to process for managing receipts 200.

Returning to FIG. 2, in one embodiment, process for managing receipts 200 is a module, a sub-program, a component, a plug-in, or a feature of, a parent and/or associated computing system implemented application and/or system, such as computing system implemented point of sale system 180 of FIG. 1, or a computing system implemented accounting system, and/or a computing system implemented financial management system, employed by a retailer and/or the user, such as computing system implemented management system 190 of FIG. 1.

Returning to FIG. 2, in one embodiment, the original purchase receipt is generated by the parent and/or associated computing system implemented application and/or system implementing and/or associated with process for managing receipts 200 and the electronic copy of the of the purchase receipt data of GENERATE ELECTRONIC COPY OF PURCHASE RECEIPT DATA OPERATION 205 is then made available to process for managing receipts 200 by the parent and/or associated computing system implemented application and/or system.

For instance, in one embodiment, when the user makes a purchase of a product and/or service at USER MAKES A PURCHASE FROM A SELLER OPERATION 203, purchase receipt data is generated by a parent and/or associated computing system implemented point of sale system and sent to a printer to create an itemized printed receipt. In one embodiment, this purchase receipt data generated by a parent and/or associated computing system implemented point of sale system is also transferred to process for managing receipts 200 at GENERATE ELECTRONIC COPY OF PURCHASE RECEIPT DATA OPERATION 205.

In one embodiment, the original purchase receipt is in an electronic format delivered to the user via e-mail and the electronic copy of the of the purchase receipt data of GENERATE ELECTRONIC COPY OF PURCHASE RECEIPT DATA OPERATION 205 is obtained from the e-mail by either transferring the purchase receipt data to process for managing receipts 200 at the same time the e-mail is generated or by obtaining the purchase receipt data from the e-mail itself.

In one embodiment, at GENERATE ELECTRONIC COPY OF PURCHASE RECEIPT DATA OPERATION 205, at least a portion of the information contained on the purchase receipt is obtained and used to generate an electronic copy of the purchase receipt data by a third party service employed by the seller, the user, or both.

In one embodiment, at GENERATE ELECTRONIC COPY OF PURCHASE RECEIPT DATA OPERATION 205, at least a portion of the information contained on the purchase receipt is obtained and used to generate an electronic copy of the purchase receipt data by any method, apparatus, process, or mechanism for transferring data and/or text from one or more devices, computing systems, server systems, databases, web site/web functions and/or any devices having a data storage capability to one or more other devices, computing systems, server systems, databases, web site/web functions and/or any devices having a data storage capability, whether known at the time of filing or as thereafter developed.

In one embodiment, once at least a portion of the information contained on the purchase receipt is obtained and used to generate an electronic copy of the purchase receipt data at GENERATE ELECTRONIC COPY OF PURCHASE RECEIPT DATA OPERATION 205, process flow proceeds to ASSOCIATE A UNIQUE IDENTIFICATION CODE WITH THE USER OPERATION 207.

In one embodiment, at ASSOCIATE A UNIQUE IDENTIFICATION CODE WITH THE USER OPERATION 207 an identification code unique to the user is created/obtained by process for managing receipts 200.

In one embodiment, at ASSOCIATE A UNIQUE IDENTIFICATION CODE WITH THE USER OPERATION 207 the identification code unique to the user is chosen by the user and provided to process for managing receipts 200 by user entry and/or designation in a manner similar to those used to choose and/or designate a user Personal Identification Number (PIN) for a bank and/or credit account.

In one embodiment, at ASSOCIATE A UNIQUE IDENTIFICATION CODE WITH THE USER OPERATION 207 the identification code unique to the user is obtained by process for managing receipts 200 from other unique user data, such as the user's telephone number. In one embodiment, the seller may already have an account assigned to the user that includes one or more sources of an identification code unique to the user. In one embodiment, the identification code unique to the user is all, or part of, the user's name.

In one embodiment, at ASSOCIATE A UNIQUE IDENTIFICATION CODE WITH THE USER OPERATION 207 the identification code unique to the user is obtained by process for managing receipts 200 from a credit and/or debit card used to make the purchase.

In one embodiment, at ASSOCIATE A UNIQUE IDENTIFICATION CODE WITH THE USER OPERATION 207 the identification code unique to the user is obtained by process for managing receipts 200 from a credit and/or debit device and/or a device having a credit/debit capability, such as a cell phone, Personal Digital Assistant (PDA), memory device/stick, smart card, or other computing device and/or system having an identification code unique to the user.

In one embodiment, once an identification code unique to the user is created/obtained and assigned to the user at ASSOCIATE A UNIQUE IDENTIFICATION CODE WITH THE USER OPERATION 207, process flow proceeds to ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209.

In one embodiment, at ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209, the identification code unique to the user created/obtained and assigned to the user at ASSOCIATE A UNIQUE IDENTIFICATION CODE WITH THE USER OPERATION 207 is associated with and/or attached to the electronic copy of the of the purchase receipt data of GENERATE ELECTRONIC COPY OF PURCHASE RECEIPT DATA OPERATION 205 to create user correlated purchase receipt data.

In one embodiment, the identification code unique to the user created/obtained and assigned to the user at ASSOCIATE A UNIQUE IDENTIFICATION CODE WITH THE USER OPERATION 207 is associated with and/or attached to the electronic copy of the of the purchase receipt data of GENERATE ELECTRONIC COPY OF PURCHASE RECEIPT DATA OPERATION 205 at ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 to create user correlated purchase receipt data by electronically adding the identification code, and/or data representing the identification code, to the electronic copy of the purchase receipt data by any one of numerous methods known to those of skill in the art.

For instance, in one embodiment, the identification code is associated with and/or attached to the electronic copy of the of the purchase receipt at ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 to create user correlated purchase receipt data by obtaining the identification code by any of the methods discussed above and then electronically adding the identification code, and/or data representing the identification code, to the electronic copy of the of the purchase receipt data automatically in a user identification field.

As another example, in one embodiment, the identification code is associated with and/or attached to the electronic copy of the of the purchase receipt at ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 to create user correlated purchase receipt data by having the user enter his or her identification code into a seller's computing system and/or computing system implemented point of sale system via a user interface device such as a keyboard, mouse, touchpad, or any other device capable of providing user input to a computing system or for translating user actions into computing system operations, whether known at the time of filing or as developed later, and then electronically adding the identification code, and/or data representing the identification code, to the electronic copy of the of the purchase receipt data.

As another example, in one embodiment, the identification code is associated with and/or attached to the electronic copy of the of the purchase receipt at ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 to create user correlated purchase receipt data by the provider of process for managing receipts and/or a third party service provider.

In one embodiment, the identification code unique to the user created/obtained and assigned to the user at ASSOCIATE A UNIQUE IDENTIFICATION CODE WITH THE USER OPERATION 207 is associated with and/or attached to the electronic copy of the of the purchase receipt data of GENERATE ELECTRONIC COPY OF PURCHASE RECEIPT DATA OPERATION 205 at ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 to create user correlated purchase receipt data by any method and/or mechanism for assigning an identification code to data, whether known at the time of filing or as developed thereafter.

In one embodiment, once the identification code unique to the user created/obtained and assigned to the user at ASSOCIATE A UNIQUE IDENTIFICATION CODE WITH THE USER OPERATION 207 is associated with and/or attached to the electronic copy of the of the purchase receipt data of GENERATE ELECTRONIC COPY OF PURCHASE RECEIPT DATA OPERATION 205 at ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 to create user correlated purchase receipt data, process flow proceeds to STORE THE USER CORRELATED PURCHASE RECEIPT DATA ON A DATA STORAGE DEVICE OPERATION 211.

In one embodiment, at STORE THE USER CORRELATED PURCHASE RECEIPT DATA ON A DATA STORAGE DEVICE OPERATION 211 the user correlated purchase receipt data of ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 is transferred to and/or stored in/on one or more storage devices.

In one embodiment, the data storage device is a database such as a designated server system or computing system, or a designated portion of one or more server systems or computing systems, or a distributed database, or an external and/or portable data storage device. In one embodiment, the data storage device is a dedicated mass storage device implemented in software, hardware, or a combination of hardware and software. In one embodiment, the data storage device is a web-based function. In one embodiment, the data storage device is a portable computing system and/or device, such as a cell phone, PDA, memory device/stick, smart card, or other computing device and/or system having a data storage capability. In one embodiment, the data storage device is a computer program product as defined herein.

For example, in one embodiment, at STORE THE USER CORRELATED PURCHASE RECEIPT DATA ON A DATA STORAGE DEVICE OPERATION 211 the user correlated purchase receipt data of ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 is stored, in whole, or in part, in a memory system, such as memory system 103 or server memory system 123, or database 170, of FIG. 1, or in a cache memory, such as cache memory 103A of FIG. 1, or in any main memory or mass memory, associated with a first computing system, such as computing system 100 described above (FIG. 1), maintained by, controlled by, accessible by, owned by, or otherwise operated by: the user and/or the user's authorized agents; the provider of process for managing receipts; a third party; and/or any service and/or product provider. In one embodiment, the data, in whole, or in part, is stored on a webpage, in a web-based system maintained by, controlled by, accessible by, owned by, or otherwise operated by: the user and/or the user's authorized agents; the provider of process for managing receipts; a third party; and/or any service and/or product provider.

In one embodiment, the user correlated purchase receipt data for all of the known user's purchases is stored in a single account assigned to the user and/or the user's agents.

In one embodiment, once the user correlated purchase receipt data of ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209 is transferred to and/or stored in/on one or more storage devices at STORE THE USER CORRELATED PURCHASE RECEIPT DATA ON A DATA STORAGE DEVICE OPERATION 211, process flow proceeds to ACCESS THE USER CORRELATED PURCHASE RECEIPT DATA ON THE DATA STORAGE DEVICE OPERATION 213.

In one embodiment, the user correlated purchase receipt data is stored at STORE THE USER CORRELATED PURCHASE RECEIPT DATA ON A DATA STORAGE DEVICE OPERATION 211 until it is needed. In one embodiment, when, and if, the purchase receipt data is needed at some future time, the purchase receipt data is made accessible to the user, and/or any authorized agents for the user, and/or any party authorized by the user, and/or any authorized program and/or electronic agent of the user, at STORE THE USER CORRELATED PURCHASE RECEIPT DATA ON A DATA STORAGE DEVICE OPERATION 211 by providing access to the user's account associated with the data storage device and/or data storage service.

In one embodiment, the user correlated purchase receipt data stored at STORE THE USER CORRELATED PURCHASE RECEIPT DATA ON A DATA STORAGE DEVICE OPERATION 211 is processed by process for managing receipts 200 to create purchase receipt data reports and/or displays using user and/or provider supplied criteria such as, but not limited to: the product and/or service purchased; a category for the product and/or service purchased; the purchase amount; the date of purchase; the location of purchase; and any other criteria associated with a given purchase designated by the user, the user's agents, the provider of process for managing receipts, and/or any other party. In one embodiment, the user correlated purchase receipt data stored at STORE THE USER CORRELATED PURCHASE RECEIPT DATA ON A DATA STORAGE DEVICE OPERATION 211 is accessed at ACCESS THE USER CORRELATED PURCHASE RECEIPT DATA ON THE DATA STORAGE DEVICE OPERATION 213 by providing the user and/or the user agents with the purchase receipt data reports and/or displays.

In one embodiment, the user correlated purchase receipt data stored at STORE THE USER CORRELATED PURCHASE RECEIPT DATA ON A DATA STORAGE DEVICE OPERATION 211 is accessed at ACCESS THE USER CORRELATED PURCHASE RECEIPT DATA ON THE DATA STORAGE DEVICE OPERATION 213 by a computing system implemented application and/or system such as computing system implemented management system 190 of FIG. 1, including, but not limited to: a computing system implemented personal financial management system; a computing system implemented business financial management system; a computing system implemented personal accounting system; a computing system implemented business accounting system; a computing system implemented tax preparation system; a computing system implemented healthcare management system; or any other a computing system implemented personal and/or business management system. In one embodiment, the computing system implemented application and/or system, such as computing system implemented management system 190 of FIG. 1, processes the user correlated purchase receipt data to create purchase receipt data reports and/or displays using user and/or provider criteria such as, but not limited to: the product and/or service purchased; the category of the product and/or service purchased; purchase amount; the date of purchase; the location of purchase; and any other criteria associated with a given purchase designated by the user, the user's agents, the provider of process for managing receipts, the provider of the other computing system implemented management system and/or any other party.

In one embodiment, once the user correlated purchase receipt data stored at STORE THE USER CORRELATED PURCHASE RECEIPT DATA ON A DATA STORAGE DEVICE OPERATION 211 is accessed at ACCESS THE USER CORRELATED PURCHASE RECEIPT DATA ON THE DATA STORAGE DEVICE OPERATION 213 and used as needed, process flow proceeds to EXIT OPERATION 230 and process for managing receipts, is exited to await the next data transfer and/or data request.

Using process for managing receipts 200, a user is provided the ability to receive, store and manage detailed purchase receipt data automatically, without having to receive and retain paper receipts. Consequently, using process for managing receipts 200, a user can keep a detailed record of purchases, and thereby retain all his or her rights and/or privileges associated with the purchases, without taking on the burden of receiving, storing, and managing hundreds, and even thousands, of documents each year.

In one embodiment, the user correlated purchase receipt data is transferred by the process for managing receipts to a user controlled computing system and/or device, such as a cell phone, PDA, memory device/stick, smart card, or other computing device and/or system having a data storage capability.

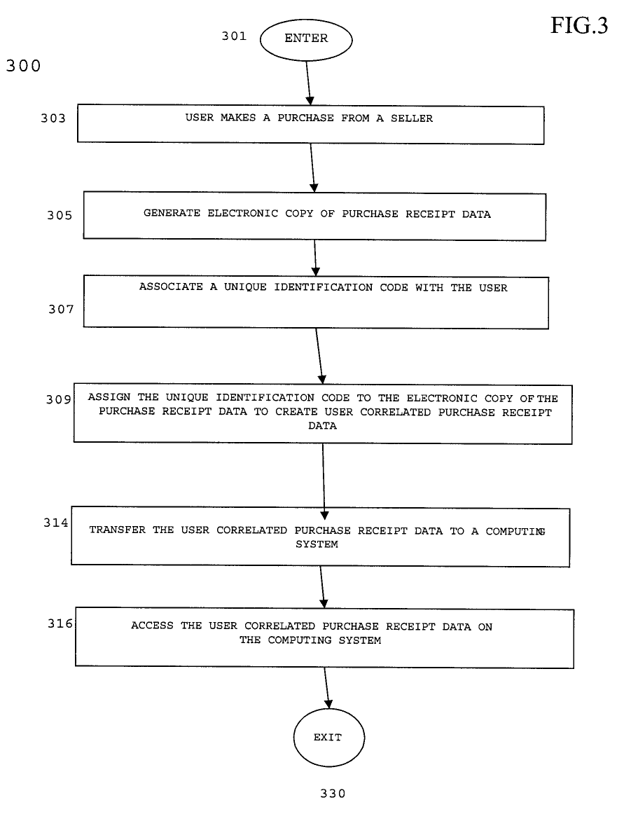

FIG. 3 a flow chart depicting a process for managing receipts 300 in accordance with one embodiment. Process for managing receipts 300 begins at ENTER OPERATION 301 of FIG. 3 and process flow proceeds to USER MAKES A PURCHASE FROM A SELLER OPERATION 303.

In one embodiment: USER MAKES A PURCHASE FROM A SELLER OPERATION 303; GENERATE ELECTRONIC COPY OF PURCHASE RECEIPT DATA OPERATION 305; ASSOCIATE A UNIQUE IDENTIFICATION CODE WITH THE USER OPERATION 307; and ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 309, of process for managing receipts 300 and FIG. 3 are substantially identical to: USER MAKES A PURCHASE FROM A SELLER OPERATION 203, GENERATE ELECTRONIC COPY OF PURCHASE RECEIPT DATA OPERATION 205; ASSOCIATE A UNIQUE IDENTIFICATION CODE WITH THE USER OPERATION 207; and ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209, of process for managing receipts 200 and FIG. 2.

In light of this fact, the discussion above with respect to: USER MAKES A PURCHASE FROM A SELLER OPERATION 203, GENERATE ELECTRONIC COPY OF PURCHASE RECEIPT DATA OPERATION 205; ASSOCIATE A UNIQUE IDENTIFICATION CODE WITH THE USER OPERATION 207; and ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 209, of process for managing receipts 200 and FIG. 2 is applicable to, and incorporated here for, similarly named and numbered operations: USER MAKES A PURCHASE FROM A SELLER OPERATION 303, GENERATE ELECTRONIC COPY OF PURCHASE RECEIPT DATA OPERATION 305; ASSOCIATE A UNIQUE IDENTIFICATION CODE WITH THE USER OPERATION 307; and ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 309, of process for managing receipts 300 and FIG. 3.

In one embodiment, once the identification code unique to the user created/obtained and assigned to the user at ASSOCIATE A UNIQUE IDENTIFICATION CODE WITH THE USER OPERATION 307 is associated with and/or attached to the electronic copy of the of the purchase receipt data of GENERATE ELECTRONIC COPY OF PURCHASE RECEIPT DATA OPERATION 305 at ASSIGN THE UNIQUE IDENTIFICATION CODE TO THE ELECTRONIC COPY OF THE PURCHASE RECEIPT DATA TO CREATE USER CORRELATED PURCHASE RECEIPT DATA OPERATION 309 to create user correlated purchase receipt data, process flow proceeds to TRANSFER THE USER CORRELATED PURCHASE RECEIPT DATA TO A COMPUTING SYSTEM OPERATION 312.

In one embodiment, at TRANSFER THE USER CORRELATED PURCHASE RECEIPT DATA TO A COMPUTING SYSTEM OPERATION 312, the user correlated purchase receipt data is transferred to computing system under the control of, and/or accessible by, the user.

In one embodiment, the computing system under the control, and/or accessible by, the user is a computing system such as computing systems 100 and 150 discussed above with respect to FIG. 1. In one embodiment, the user correlated purchase receipt data is transferred from a seller's computing system and/or computing system implemented point of sale system at TRANSFER THE USER CORRELATED PURCHASE RECEIPT DATA TO A COMPUTING SYSTEM OPERATION 312 to a remotely located computing system under the control and/or accessible by the user over a network such as network 130 of FIG. 1.

Returning to FIG. 3, in one embodiment, the user correlated purchase receipt data is transferred from a seller's computing system and/or computing system implemented point of sale system at TRANSFER THE USER CORRELATED PURCHASE RECEIPT DATA TO A COMPUTING SYSTEM OPERATION 312 to a remotely located computing system under the control, and/or accessible by, the user via a computing program product such as a data disk or portable hard drive.

In one embodiment, the computing system under the control, and/or accessible by, the user is a portable device, such as a cell phone, PDA, memory device/stick, smart card, or other computing device and/or system. In one embodiment, the computing system under the control, and/or accessible by, the user is a credit and/or debit device and/or credit/debit module associated with a portable device, such as a cell phone, PDA, memory device/stick, smart card, or other personal computing device and/or system.

As a specific example, it is currently common in Asia and parts of Europe for a cell phone or PDA to include a credit/debit card-like capability whereby an RFID device associated with the cell phone or PDA, and the user, is scanned and a charge is automatically taken from the associated credit/debit account. Currently, despite the highly automated nature of these transactions, the consumer is still typically presented with a printed purchase receipt. However, using one embodiment of process for managing receipts 300, at TRANSFER THE USER CORRELATED PURCHASE RECEIPT DATA TO A COMPUTING SYSTEM OPERATION 312 the user correlated purchase receipt data is transferred to the cell phone or PDA at the time of purchase. In one embodiment, the user correlated purchase receipt data can then optionally be uploaded and/or transferred to a long term storage device at the user's convenience.

In one embodiment, once the user correlated purchase receipt data is transferred to a computing system under the control of, and/or accessible by, the user at TRANSFER THE USER CORRELATED PURCHASE RECEIPT DATA TO A COMPUTING SYSTEM OPERATION 312, process flow proceeds to ACCESS THE USER CORRELATED PURCHASE RECEIPT DATA ON THE COMPUTING SYSTEM OPERATION 314.

In one embodiment, the user correlated purchase receipt data is stored by the user computing system of TRANSFER THE USER CORRELATED PURCHASE RECEIPT DATA TO A COMPUTING SYSTEM OPERATION 312 until it is needed. In one embodiment, when, and if, the purchase receipt data is needed at some future time, the purchase receipt data is made accessible to the user, and/or any authorized agents for the user, and/or any party authorized by the user, and/or any authorized program and/or electronic agent of the user, at ACCESS THE USER CORRELATED PURCHASE RECEIPT DATA ON THE COMPUTING SYSTEM OPERATION 314 by providing access to the user computing system of TRANSFER THE USER CORRELATED PURCHASE RECEIPT DATA TO A COMPUTING SYSTEM OPERATION 312.

In one embodiment, the user correlated purchase receipt data stored is processed by process for managing receipts 300 to create purchase receipt data reports and/or displays using user and/or provider supplied criteria such as, but not limited to: the product and/or service purchased; a category for the product and/or service purchased; the purchase amount; the date of purchase; the location of purchase; and any other criteria associated with a given purchase designated by the user, the user's agents, the provider of process for managing receipts, and/or any other party. In this embodiment, the user correlated purchase receipt data is accessed at ACCESS THE USER CORRELATED PURCHASE RECEIPT DATA ON THE COMPUTING SYSTEM OPERATION 314 by providing the user, and/or the user agents, with the purchase receipt data reports and/or displays.

In one embodiment, the user correlated purchase receipt data is accessed at ACCESS THE USER CORRELATED PURCHASE RECEIPT DATA ON THE COMPUTING SYSTEM OPERATION 314 by a computing system implemented application and/or system such as computing system implemented management system 190 of FIG. 1, including, but not limited to: a computing system implemented personal financial management system; a computing system implemented business financial management system; a computing system implemented personal accounting system; a computing system implemented business accounting system; a computing system implemented tax preparation system; a computing system implemented healthcare management system; or any other a computing system implemented personal and/or business management system. In one embodiment, the computing system implemented application and/or system such as computing system implemented management system 190 of FIG. 1, processes the user correlated purchase receipt data to create purchase receipt data reports and/or displays using user and/or provider criteria such as, but not limited to: the product and/or service purchased; the category of the product and/or service purchased; purchase amount; the date of purchase; the location of purchase; and any other criteria associated with a given purchase designated by the user, the user's agents, the provider of process for managing receipts, the provider of the other computing system implemented management system and/or any other party.

In one embodiment, once the user correlated purchase receipt data is accessed at ACCESS THE USER CORRELATED PURCHASE RECEIPT DATA ON THE COMPUTING SYSTEM OPERATION 314, and used as needed, process flow proceeds to EXIT OPERATION 330 and process for managing receipts 300, is exited to await the next data transfer and/or data request.

Using a process for managing receipts, such as processes for managing receipts 200 and/or 300 discussed herein, a user is provided the ability to receive, store and manage detailed purchase receipt data automatically, without having to receive and retain paper receipts. Consequently, using a process for managing receipts, such as processes for managing receipts 200 and/or 300 discussed herein, a user can keep a detailed record of a purchase, and thereby retain all his or her rights and/or privileges associated with his or her purchases, without taking on the burden of receiving, storing, and managing hundreds, and even thousands, of documents each year. Consequently, the user is provided the opportunity to retain more detailed records, and provide required proof of purchases when needed, with little, or no, burden being imposed on the user.

As discussed in more detail above, using the above embodiments, with little or no modification and/or user input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “generating”, “associating”, “assigning”, “obtaining”, “selecting”, “transferring”, “storing”, “providing”, etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented process for managing receipts comprising:
generating a purchase receipt associated with the purchase of a product and/or service, the product and/or service being purchased by a user from a seller, the purchase receipt comprising purchase receipt data;
generating an electronic copy of the purchase receipt data;
creating a unique identification code, the unique identification code being associated with the user;
associating the unique identification code with the electronic copy of the purchase receipt data, thereby correlating the electronic copy of the purchase receipt data to the user;
storing the user correlated electronic copy of the purchase receipt data in a data storage system, the user correlated electronic copy of the purchase receipt data being accessible through an account associated with the user.

2. The computing system implemented process for managing receipts of claim 1, wherein;
the data storage system comprises a web-based system and the user correlated electronic copy of the purchase receipt data is accessible through a web-based account associated with the user via a network.

3. The computing system implemented process for managing receipts of claim 2, wherein;
the network is the Internet.

4. The computing system implemented process for managing receipts of claim 1, wherein;
generating an electronic copy of the purchase receipt data is performed by a computing system implemented management system operating on a computing system associated with the seller.

5. The computing system implemented process for managing receipts of claim 4, wherein;
the computing system implemented management system is a computing system implemented point of sale system.

6. The computing system implemented process for managing receipts of claim 1, wherein;
associating the unique identification code with the electronic copy of the purchase receipt data to correlate the electronic copy of the purchase receipt data with the user comprises attaching data representing the unique identification code to the electronic copy of the purchase receipt data.

7. A computing system implemented process for managing receipts comprising:
generating a purchase receipt associated with the purchase of a product and/or service, the product and/or service being purchased by a user from a seller, the purchase receipt comprising purchase receipt data;
generating an electronic copy of the purchase receipt data;
creating a unique identification code, the unique identification code being associated with the user;
associating the unique identification code with the electronic copy of the purchase receipt data, thereby correlating the electronic copy of the purchase receipt data to the user;
transferring the user correlated electronic copy of the purchase receipt data to a user computing system.

8. The computing system implemented process for managing receipts of claim 7, wherein;
the user computing system is a cellular telephone.

9. The computing system implemented process for managing receipts of claim 7, wherein;
the user computing system is a personal digital assistant.

10. The computing system implemented process for managing receipts of claim 7, wherein;
generating an electronic copy of the purchase receipt data is performed by a computing system implemented management system operating on a computing system associated with the seller.

11. The computing system implemented process for managing receipts of claim 10, wherein;
the computing system implemented management system is a computing system implemented point of sale system.

12. The computing system implemented process for managing receipts of claim 7, wherein;
associating the unique identification code with the electronic copy of the purchase receipt data to correlate the electronic copy of the purchase receipt data with the user is performed by the user computing system.

13. The computing system implemented process for managing receipts of claim 12, wherein;
associating the unique identification code with electronic copy of the purchase receipt data to correlate the electronic copy of the purchase receipt data with the user comprises attaching data representing the unique identification code to the electronic copy of the purchase receipt data.

14. A system for managing receipts comprising:
a seller computer system;
a data storage system; and
a processor, the processor capable of executing at least part of a process for managing receipts, the process for managing receipts comprising:
generating a purchase receipt associated with the purchase of a product and/or service, the product and/or service being purchased by a user from a seller, the purchase receipt comprising purchase receipt data;
generating an electronic copy of the purchase receipt data;
creating a unique identification code, the unique identification code being associated with the user;
associating the unique identification code with the electronic copy of the purchase receipt data, thereby correlating the electronic copy of the purchase receipt data to the user;
storing the user correlated electronic copy of the purchase receipt data in the data storage system, the user correlated electronic copy of the purchase receipt data being accessible through an account associated with the user.

15. The system for managing receipts of claim 14, wherein;
the data storage system comprises a web-based system and the user correlated electronic copy of the purchase receipt data is accessible through a web-based account associated with the user via a network.

16. The system for managing receipts of claim 15, wherein;
the network is the Internet.

17. The system for managing receipts of claim 14, wherein;
generating an electronic copy of the purchase receipt data is performed by a computing system implemented management system operating on the seller computing system.

18. The system for managing receipts of claim 17, wherein;
the computing system implemented management system is a computing system implemented point of sale system.

19. The system for managing receipts of claim 14, wherein;
associating the unique identification code with the electronic copy of the purchase receipt data to correlate the electronic copy of the purchase receipt data with the user comprises attaching data representing the unique identification code to the electronic copy of the purchase receipt data.

20. A system for managing receipts comprising:
a seller computer system;
a user computer system;
a data storage system; and
a processor, the processor capable of executing at least part of a process for managing receipts, the process for managing receipts comprising:
generating a purchase receipt associated with the purchase of a product and/or service, the product and/or service being purchased by a user from a seller, the purchase receipt comprising purchase receipt data;
generating an electronic copy of the purchase receipt data;
creating a unique identification code, the unique identification code being associated with the user;
associating the unique identification code with the electronic copy of the purchase receipt data, thereby correlating the electronic copy of the purchase receipt data to the user;
transferring the user correlated electronic copy of the purchase receipt data to the user computing system.

21. The system for managing receipts of claim 20, wherein;
the user computing system is a cellular telephone.

22. The system for managing receipts of claim 20, wherein;
the user computing system is a personal digital assistant.

23. The system for managing receipts of claim 20, wherein;
generating an electronic copy of the purchase receipt data is performed by a computing system implemented management system operating on the seller computing system.

24. The system for managing receipts of claim 23, wherein;
the computing system implemented management system is a computing system implemented point of sale system.

25. The system for managing receipts of claim 20, wherein;
associating the unique identification code with the electronic copy of the purchase receipt data to correlate the electronic copy of the purchase receipt data with the user is performed by the user computing system.

26. The system for managing receipts of claim 25, wherein;
associating the unique identification code with electronic copy of the purchase receipt data to correlate the electronic copy of the purchase receipt data with the user comprises attaching data representing the unique identification code to the electronic copy of the purchase receipt data.

27. A computer program product for managing receipts comprising:
a computer readable medium;
and computer program code, encoded on the computer readable medium, comprising computer readable instructions for:
generating a purchase receipt associated with the purchase of a product and/or service, the product and/or service being purchased by a user from a seller, the purchase receipt comprising purchase receipt data;
generating an electronic copy of the purchase receipt data;
creating a unique identification code, the unique identification code being associated with the user;
associating the unique identification code with the electronic copy of the purchase receipt data, thereby correlating the electronic copy of the purchase receipt data to the user;
storing the user correlated electronic copy of the purchase receipt data in a data storage system, the user correlated electronic copy of the purchase receipt data being accessible through an account associated with the user.

28. The computer program product for managing receipts of claim 27, wherein;
the data storage system comprises a web-based system and the user correlated electronic copy of the purchase receipt data is accessible through a web-based account associated with the user via a network.

29. The computer program product for managing receipts of claim 28, wherein;
the network is the Internet.

30. The computer program product for managing receipts of claim 27, wherein;
generating an electronic copy of the purchase receipt data is performed by a computing system implemented management system operating on a computing system associated with the seller.

31. The computer program product for managing receipts of claim 30, wherein;
the computing system implemented management system is a computing system implemented point of sale system.

32. The computer program product for managing receipts of claim 27, wherein;
associating the unique identification code with the electronic copy of the purchase receipt data to correlate the electronic copy of the purchase receipt data with the user comprises attaching data representing the unique identification code to the electronic copy of the purchase receipt data.

33. A computer program product for managing receipts comprising:
a computer readable medium;
and computer program code, encoded on the computer readable medium, comprising computer readable instructions for:
generating a purchase receipt associated with the purchase of a product and/or service, the product and/or service being purchased by a user from a seller, the purchase receipt comprising purchase receipt data;
generating an electronic copy of the purchase receipt data;
creating a unique identification code, the unique identification code being associated with the user;
associating the unique identification code with the electronic copy of the purchase receipt data, thereby correlating the electronic copy of the purchase receipt data to the user;
transferring the user correlated electronic copy of the purchase receipt data to a user computing system.

34. The computer program product for managing receipts of claim 33, wherein;
the user computing system is a cellular telephone.

35. The computer program product for managing receipts of claim 33, wherein;
the user computing system is a personal digital assistant.

36. The computer program product for managing receipts of claim 33, wherein;
generating an electronic copy of the purchase receipt data is performed by a computing system implemented management system operating on a computing system associated with the seller.

37. The computer program product for managing receipts of claim 36, wherein;
the computing system implemented management system is a computing system implemented point of sale system.

38. The computer program product for managing receipts of claim 33, wherein;
associating the unique identification code with the electronic copy of the purchase receipt data to correlate the electronic copy of the purchase receipt data with the user is performed by the user computing system.

39. The computer program product for managing receipts of claim 38, wherein;
associating the unique identification code with electronic copy of the purchase receipt data to correlate the electronic copy of the purchase receipt data with the user comprises attaching data representing the unique identification code to the electronic copy of the purchase receipt data.
